(19) United States
(12) Patent Application Publication
(10) Pub. No.: US 2015/0148982 A1
(43) Pub. Date: May 28, 2015

(54) PROTECTIVE COVER FOR ELECTRONIC DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventor: JIAN-GUO WU, Shenzhen (CN)

(21) Appl. No.: 14/541,939

(22) Filed: Nov. 14, 2014

(30) Foreign Application Priority Data
Nov. 22, 2013 (CN) 201310592784.7

(51) Int. Cl. G05D 23/19

(52) U.S. Cl. CPC G05D 23/19
USPC 700/300

(57) ABSTRACT

A protective cover for protecting an electronic device and maintaining a proper operating temperature for the electronic device includes a housing sleeved on the electronic device, a sensing element, a heat generation element, a power supply, and a microprocessor. The sensing element is arranged in the housing and is configured for sensing ambient temperature. The heat generation element is arranged in the housing and generates heat when powered. The microprocessor is configured to compare the sensed temperature value with a predetermined range and control the power supply to the heat generation element if the sensed temperature value is smaller than a minimum of a predetermined range of temperatures.

### CROSS-REFERENCE TO RELATED APPLICATIONS

This application claims priority to Chinese Patent Application No. 201310592784.7 filed on Nov. 22, 2013, the contents of which are incorporated by reference herein.

### FIELD

The present disclosure relates to protective coverings for devices.

### BACKGROUND

Electronic devices may be automatically powered off if the ambient temperature is too low, which is inconvenient for users.

### BRIEF DESCRIPTION OF THE DRAWINGS

Implementations of the present technology will now be described, by way of example only, with reference to the attached figures.

FIG. 1 is an isometric view showing a protective cover for electronic devices, in accordance with an exemplary embodiment.

FIG. 2 is a block diagram of the protective cover of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a protective cover for protecting an electronic device and insulating for the electronic device against changes in external temperature. The protective cover includes a housing sleeved on the electronic device, a sensing element, a heat generation element, a power supply, and a microprocessor. The sensing element is arranged in the housing and is configured for sensing an ambient temperature in which the electronic device located. The heat generation element is arranged in the housing and is configured for generating heat on when supplied with power. The microprocessor is configured to compare the sensed ambient temperature with a predetermined range, and control the power supply to supply power to the heat generation element if the sensed ambient temperature is below the predetermined range.

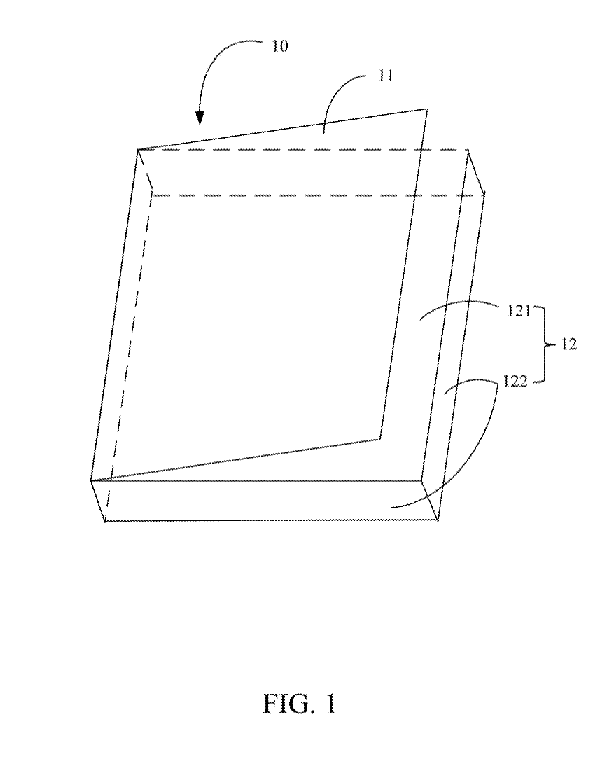

FIG. 1 illustrates a protective cover 100 of the present disclosure. The protective cover 100 can include a housing 10 sleeved on an electronic device (not shown). The housing 10 can include an upper cover 11 and a lower cover 12. The lower cover 12 can include a bottom 121 and a sidewall 122 vertically protruding from edges of the bottom 121. In at least one embodiment, both the upper cover 11 and the lower cover 12 can include a sandwiched layer (not shown) which is composed of two layers of material the same as the material of the housing 10.

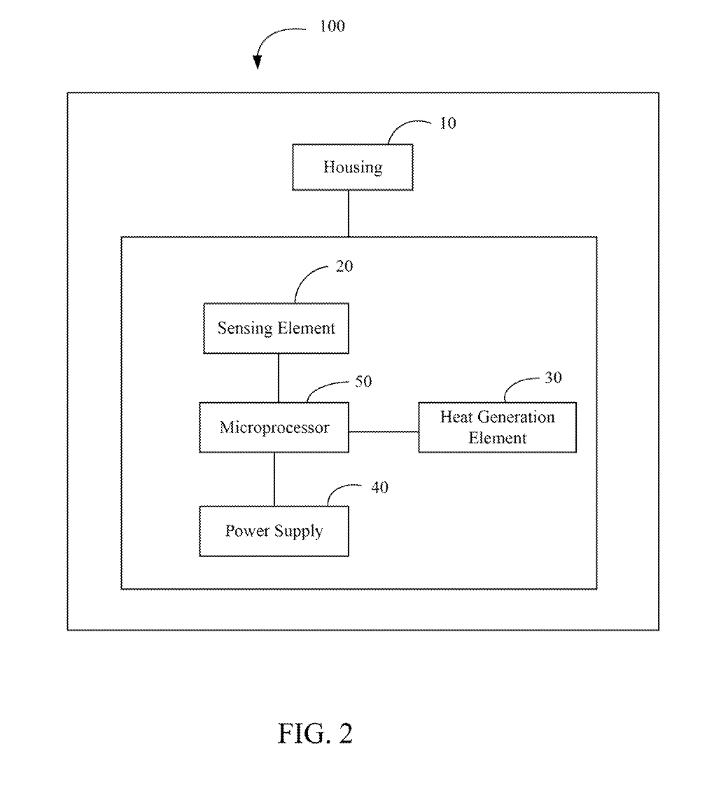

FIG. 2 illustrates a protective cover 100 in block form. The protective cover 100 can also include a sensing element 20, a heat generation element 30, a power supply 40, and a microprocessor 50. The heat generation element 30 and the power supply 40 are both coupled to the microprocessor 50. The sensing element 20, the heat generation element 30, and the microprocessor 50 can be arranged in the sandwiched layer of the housing 10.

In at least one embodiment, the sensing element 20, the heat generation element 30, and the microprocessor 50 are arranged in the sandwiched layer of the lower cover 12. The power supply 40 can be a battery. The power supply 40 is arranged in the housing 10. In an alternative embodiment, the power supply 40 can be an external power supply connected to the protective cover 100. The housing 10 can define an opening for the wires/interfaces of the external power supply to pass power to the protective cover 100.

The heat generation element 30 can be coupled to the power supply 40. The heat generation element 30 is affixed on the bottom 121 of the lower cover 12. In at least one embodiment, the heat generation element 30 can be a pad which can generate heat when being supplied with power. The cover 10 can be composed of heat-resistant material.

The sensing element 20 is coupled to the microprocessor 50, and can be configured to sense a value of ambient temperature in which the electronic device is located. The sensing element 20 transmits the sensed temperature value to the microprocessor 50. In at least one embodiment, the sensing element 20 is a temperature sensor.

The microprocessor 50 compares the temperature value sensed by the sensing element 20 with a predetermined range of temperatures to determine whether the ambient temperature allows operation of the electronic device. The predetermined range of temperatures is between −40 centigrade degrees to 85 centigrade degrees.

In at least one embodiment, if the sensed temperature value falls within the predetermined range, the microprocessor 50 determines that the ambient temperature does not prevent the use of the electronic device.

If the sensed temperature value is lower than a minimum (eg. −40 centigrade degrees) of the predetermined range, the microprocessor 50 determines that the ambient temperature is too low and prevents the use of the electronic device. In other words, the microprocessor 50 determines that the ambient temperature is not suitable for the electronic device. The microprocessor 50 controls the power supply 40 to supply power to the heat generation element 30 to activate the heat generation element 30, thus heating both the electronic device coupled to the protective cover 100 and the atmosphere around the electronic device. The value of the temperature of the electronic device is adjusted to a value which enables the use of the electronic device. Thus, even if the electronic device coupled to the protective cover 100 is in a low temperature location which is not suitable for using the electronic device, the protective cover 100 can automatically heat the electronic device and the atmosphere around the electronic device to enable normal usage of the electronic device.

If the sensed temperature value is larger than a maximum (eg. 85 centigrade degrees) of the predetermined range, the microprocessor 50 determines that the ambient temperature is too high and is not suitable for using the electronic device. The microprocessor 50 disconnects the power supply 40 from the heat generation element 30. The heat generation element 30 then stops heating the electronic device.

The embodiments shown and described above are only examples. Many details are often found in the art such as the other features of a protective cover. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including, the full extent established by the broad general meaning of the terms used in the claims. It will therefore be appreciated that the embodiments described above may be modified within the scope of the claims.

What is claimed is:

1. A protective cover, comprising:
a housing, sleeved on an electronic device;
a sensing element, arranged in the housing and configured for sensing an ambient temperature in which the electronic device located;
a heat generation element, arranged in the housing and configured for generating heat when supplied power;
a power supply; and
a microprocessor, configured to compare the sensed ambient temperature with a predetermined range of temperatures, and control the power supply to supply power to the heat generation element if the sensed ambient temperature is lower than a minimum of a predetermined range.

2. The protective cover as claimed in claim 1, wherein the microprocessor is also configured to disconnect a connection between the supply power and the heat generation element if the sensed temperature value is larger than a maximum of the predetermined range.

3. The protective cover as claimed in claim 2, wherein the cover is composed of heat-resistant material.

4. The protective cover as claimed in claim 1, wherein the heat generation element is a pad and is affixed on a bottom of the lower cover.

5. The protective cover as claimed in claim 1, wherein the sensing element is a temperature sensor.

6. The protective cover as claimed in claim 1, wherein the power supply is arranged in the housing.
